(19) United States
(12) Patent Application Publication
(10) Pub. No.: US 2025/0008204 A1
(43) Pub. Date: Jan. 2, 2025

(54) IMAGING DEVICE

(71) Applicant: NIKON CORPORATION, Tokyo (JP)

(72) Inventors: Seiji TAKANO, Yokohama-shi (JP); Juichiro KONDO, Yokohama-shi (JP); Masaki ANDO, Kamakura-shi (JP); Masashi SAKAMAKI, Tokyo (JP); Tatsuya MIYAZAKI, Kawaguchi-shi (JP)

(73) Assignee: NIKON CORPORATION, Tokyo (JP)

(21) Appl. No.: 18/707,444

(22) PCT Filed: Oct. 28, 2022
(86) PCT No.: PCT/JP2022/040317

§ 371 Date: Aug. 2, 2024

(30) Foreign Application Priority Data
Nov. 9, 2021 (JP) 2021-182404

(51) Int. Cl. H04N 23/52

(52) U.S. Cl. CPC H04N 23/52

(57) ABSTRACT

In an imaging device, a heat dissipation unit including a fan is disposed at a left side edge when viewed from an imaging device operator when the imaging device is held at a lateral position.

### TECHNICAL FIELD

Embodiments of the present invention relates to an imaging device.

Priority is claimed on Japanese Patent Application No. 2021-182404, filed Nov. 9, 2021, the content of which is incorporated herein by reference.

### BACKGROUND ART

Conventionally, an imaging device including a heat generator, a housing that houses the heat generator, and a heat dissipation means for dissipating heat generated by the heat generator to the outside is known (refer to Patent Literature 1, for example).

### CITATION LIST

### Patent Literature

### [Patent Literature 1]

Japanese Unexamined Patent Application, First Publication No. 2010-72338

### SUMMARY OF INVENTION

### Technical Problem

One aspect of the present invention is an imaging device in which a heat dissipation part including a fan is disposed at the left side edge when viewed from an imaging device operator in a case where the imaging device is held at a lateral position.

### BRIEF DESCRIPTION OF DRAWINGS

FIG. 1 is a schematic diagram showing an example of a camera body of an imaging device according to the present embodiment.

FIG. 2 is a schematic diagram showing Example 1 of the imaging device according to the present embodiment.

FIG. 3 is a block diagram showing an example of the camera body of the imaging device according to the present embodiment.

FIG. 4A is a perspective view showing Example 1 of a heat dissipation part of the imaging device according to the present embodiment.

FIG. 4B is a perspective view showing Example 1 of the heat dissipation part of the imaging device according to the present embodiment.

FIG. 5 is a diagram showing an example of a fan of the heat dissipation part of the imaging device according to the present embodiment.

FIG. 6A is a diagram showing Example 1 of fan arrangement.

FIG. 6B is a diagram showing Example 2 of fan arrangement.

FIG. 7 is a diagram showing an example of assembly of the imaging device according to the present embodiment.

FIG. 8A is a schematic diagram showing Example 2 of an imaging device according to the present embodiment.

FIG. 8B is a schematic diagram showing Example 3 of an imaging device according to the present embodiment.

FIG. 9 is a schematic diagram showing Example 1 of an imaging device according to a modified example of the embodiment.

FIG. 10 is a diagram showing Example 2 of an imaging device according to a modified example of the embodiment.

FIG. 11A is a diagram showing Example 3 of an imaging device according to a modified example of the embodiment.

FIG. 11B is a diagram showing Example 3 of an imaging device according to a modified example of the embodiment.

### DESCRIPTION OF EMBODIMENTS

### First Embodiment

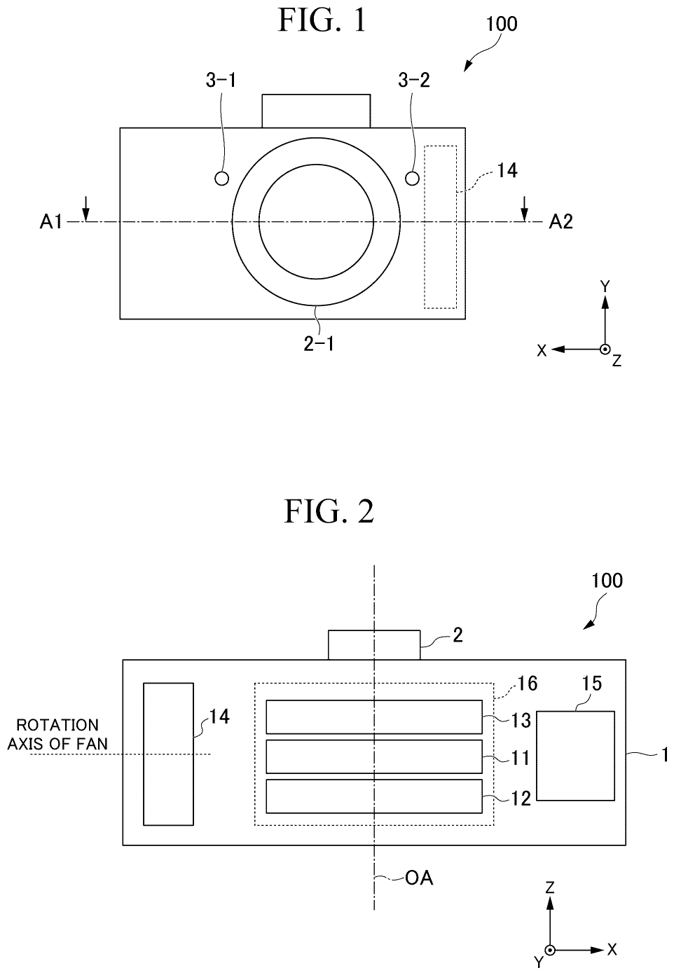

Hereinafter, an imaging device according to the present embodiment will be described with reference to the drawings. FIG. 1 is a schematic diagram showing an example of a camera body of an imaging device according to the present embodiment.

The imaging device 100 includes a camera body 1, a lens mount 2-1, a microphone 3-1, and a microphone 3-2. The two microphones, the microphone 3-1 and the microphone 3-2, form a stereo microphone. The microphone 3-1 and the microphone 3-2 are placed away from a fan 14-1, which is a sound generation source. A lens unit is attached to the camera body 1. The microphone 3-1 and the microphone 3-2 are provided, for example, around the lens mount 2-1.

FIG. 2 is a schematic diagram showing Example 1 of the imaging device according to the present embodiment. FIG. 2 is a cross-sectional view of the imaging device 100 shown in FIG. 1 taken along A1-A2 when viewed in the direction of the arrow. FIG. 2 is a sectional view when the lens unit 2 is attached to the camera body 1 of FIG. 1.

The lens unit 2 includes an optical system arranged along an optical axis OA within the lens barrel thereof. The optical system guides an incident subject light flux to an imaging unit 16 of the camera body 1.

The camera body 1 includes a heat dissipation part 14, a battery chamber 15, and the imaging unit 16. The imaging unit 16 includes a first processing unit 11, a second processing unit 12, and an image sensor 13. The first processing unit 11, the second processing unit 12, and the image sensor 13 are disposed in the housing of the camera body 1 at positions that overlap in the direction along the optical axis OA of the imaging device 100.

In the present embodiment, the direction along the optical axis OA is defined as the Z-axis. That is, the direction in which a subject light flux is incident on the image sensor 13 included in the imaging unit 16 is defined as the Z-axis. Specifically, the direction in which the subject light flux is incident is defined as the negative side of the Z-axis, and the opposite direction is defined as the positive side of the Z-axis.

The longitudinal direction of the camera body 1 is defined as the X-axis. The lateral direction of the camera body 1 is defined as the Y-axis. Specifically, the X-axis and Y-axis are defined as shown in FIG. 2.

Note that for convenience of description, the positive side of the Z-axis may be referred to as the front, front side, and the like. Further, the negative side of the Z-axis may be referred to as the rear, rear side, and the like. The negative side of the Z-axis may be referred to as the back side and the like. The negative side of the X-axis may be referred to as the left side. The positive side of the X-axis may be referred to as the right side.

The battery chamber 15 is a part that serves as a space for storing a battery. As an example, the battery chamber 15 is disposed on the right side of the camera body 1 (on the positive side of the X-axis).

The heat dissipation part 14 is disposed on the negative left side of the X-axis. The heat dissipation part 14 will be described later.

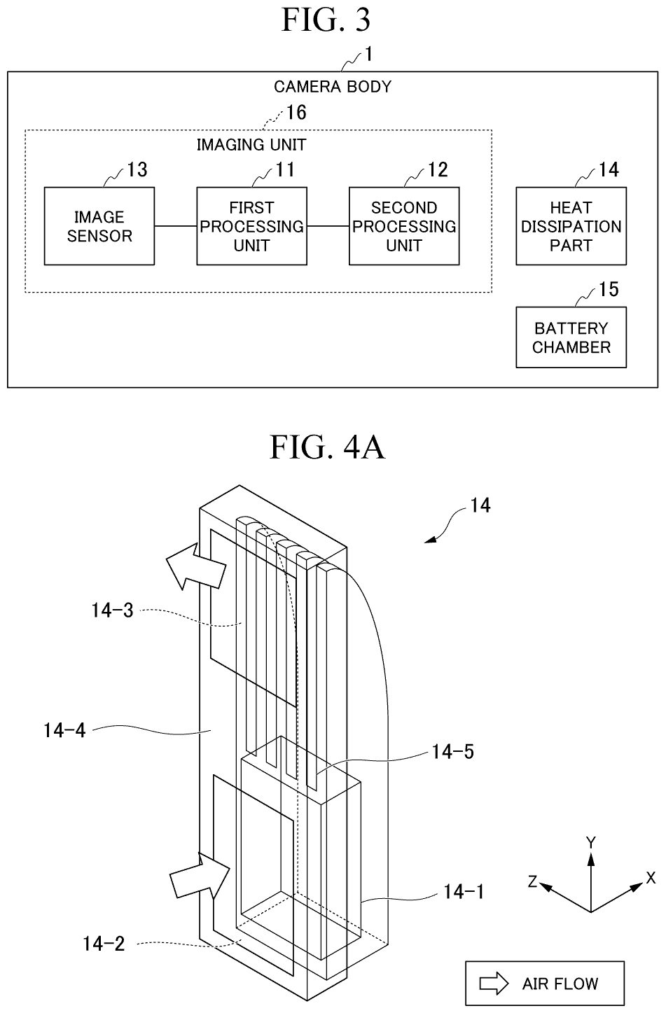

FIG. 3 is a block diagram showing an example of the camera body of the imaging device according to the present embodiment. As described above, the camera body 1 includes, for example, the imaging unit 16, the heat dissipation part 14, and the battery chamber 15. The imaging unit 16 includes the image sensor 13, the first processing unit 11, and the second processing unit 12.

The image sensor 13 is configured by using, for example, a complementary metal oxide semiconductor (CMOS). The image sensor 13 photoelectrically converts incident light to generate image data. Further, the image sensor 13 generates an imaging signal by performing predetermined signal processing such as noise removal and white balance adjustment on the generated image data.

The first processing unit 11 is configured by using, for example, a central processing unit (CPU). The first processing unit 11 generates development data on the basis of the imaging signal generated by the image sensor. The first processing unit 11 executes various kinds of processing as necessary on the generated development data.

The second processing unit 12 includes, for example, an application processor that executes an operating system, various types of application software, etc., and an interface connector. The second processing unit 12 executes display of image data generated by the image sensor 13. The second processing unit 12 stores development data generated by the first processing unit 11 and transmits it to the outside via a predetermined network from the interface connector.

The heat dissipation part 14 mainly radiates heat generated in the second processing unit 12. Further, the heat dissipation part 14 may be configured to radiate any one of the heat generated by the first processing unit 11, the heat generated by the second processing unit 12, and the heat generated by the image sensor 13, or a plurality of heats corresponding to any combination thereof.

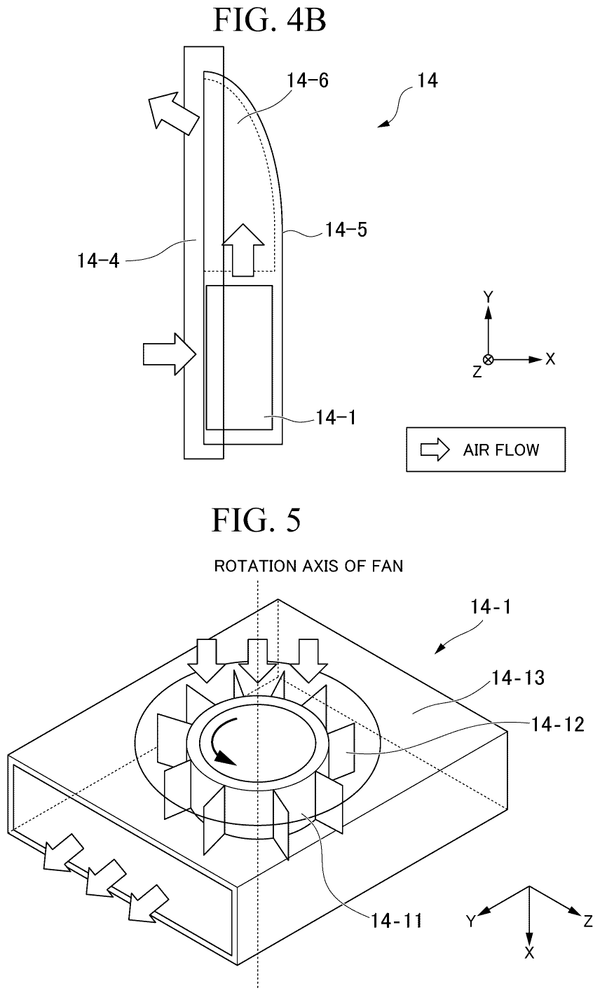

FIG. 4A is a perspective view showing Example 1 of the heat dissipation part of the imaging device according to the present embodiment. FIG. 4A is a diagram of the heat dissipation part 14 viewed from the negative side of the X-axis in the positive direction. As shown in FIG. 4A, the heat dissipation part 14 is disposed on the left side surface of the camera body 1 as viewed from the imaging device operator when the imaging device 100 is held at a lateral position. The heat dissipation part 14 includes the fan 14-1, an intake port 14-2, and an exhaust port 14-3.

With this configuration, the heat dissipation part 14 can be disposed on the left side of the camera body 1, and thus the microphones (microphone 3-1 and microphone 3-2) can be disposed far away from the fan 14-1 (which is the sound generation source). Therefore, it is possible to reduce the amount of noise such as rotation sound of the fan 14-1 being collected by the microphones 3-1 and 3-2 provided around the lens mount 2-1.

Further, the intake port 14-2 and the exhaust port 14-3 are provided on one main surface 14-4 of the heat dissipation part 14. An example of one main surface is the side of the imaging device 100. Specifically, the intake port 14-2 and the exhaust port 14-3 are provided on the left side surface of the camera body 1. The intake port 14-2 is provided at the lower part (the negative side of the Y-axis with respect to the exhaust port 14-3 in FIG. 4A) of one main surface 14-4 of the heat dissipation part 14, and the exhaust port 14-3 is provided at the upper part (the positive side of the Y-axis with respect to the intake port 14-2 in FIG. 4A) of one main surface 14-4 of the heat dissipation part 14. With this configuration, since the heat dissipation part 14 can take in air from the bottom and exhaust air from the top when the imaging device 100 is held at a lateral position, it is possible to prevent the air taken in from the intake port 14-2 from being heated by the air exhausted from the exhaust port 14-3, and thus can efficiently discharge the heat.

Furthermore, compared to a case in which the intake port 14-2 and the exhaust port 14-3 are not provided on one main surface of the heat dissipation part 14, members related to the fan 14-1 can be contained in one unit, and thus the structure of the members becomes simpler and replacement of the members becomes easier.

FIG. 4B is a perspective view showing Example 1 of the heat dissipation part of the imaging device according to the present embodiment. FIG. 4B is a diagram of the heat dissipation part 14 viewed from the negative side of the Z-axis in the positive direction. As shown in FIG. 4B, the heat dissipation part 14 includes a heat dissipation member 14-6 and an envelope 14-5 in addition to the fan 14-1. Inside of the heat dissipation part 14, the heat dissipation member 14-6, which becomes high temperature, is disposed at the top, which creates a chimney effect (phenomenon that when there is air inside that is hotter than the outside air, since hot air has a lower density than cold air and thus buoyancy occurs in the air, the warm air is caused to move from the bottom to the top), resulting in creation of a flow of air from the intake port to the exhaust port. Since this air flow is combined with exhaust heat from the fan 14-1, heat can be effectively exhausted.

FIG. 5 is a diagram showing an example of a fan of the heat dissipation part of the imaging device according to the present embodiment. An example of the fan 14-1 is a small blower type fan. By using the small fan 14-1, power consumption can be reduced compared to a case in which a medium-sized or large-sized fan is used.

The fan 14-1 includes a motor 14-11, runners 14-12, and a scroll 14-13. The runners 14-12 are arranged in a cylindrical shape. The fan 14-1 creates a swirling flow in a direction substantially orthogonal to the rotation axis according to rotation of the runners 14-12. The swirling flow is rectified in one direction by the scroll 14-13. By narrowing the exhaust port, the wind can be concentrated in a certain direction.

The rotation axis of the fan 14-1 and the optical axis OA are arranged to be orthogonal to each other. With this configuration, the optical axis OA and the fan 14-1 can be arranged such that they do not overlap and the thickness in the Z-axis direction can also be reduced without increasing the length of the imaging device 100 in the X-axis direction as compared to a case in which the rotation axis of the fan 14-1 and the optical axis OA are arranged such that they are not orthogonal to each other.

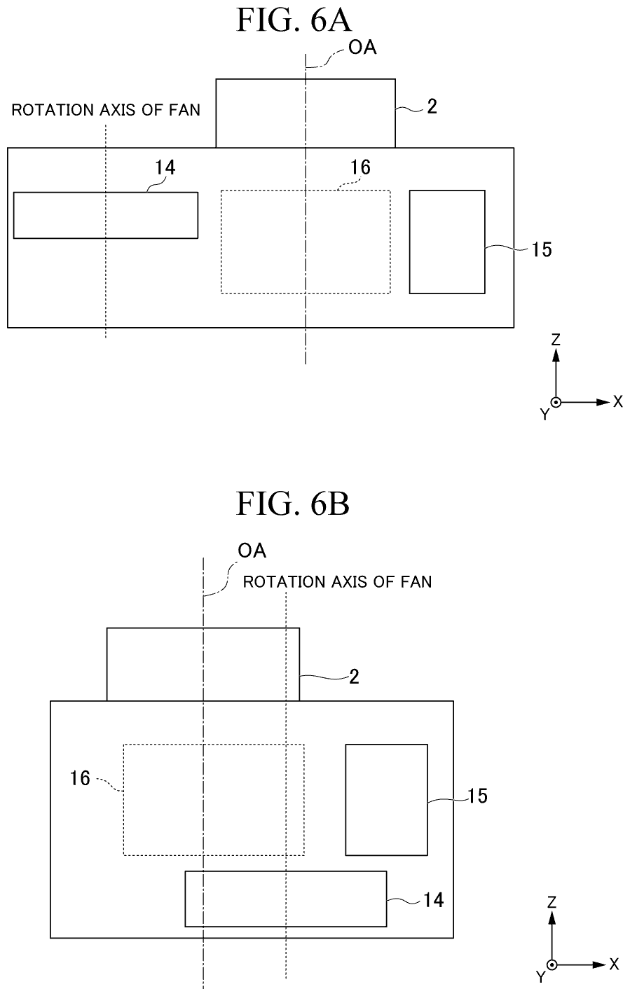

FIGS. 6A and 6B are diagrams showing an example of disposition of the fan. As shown in FIG. 6A, if the fan 14-1 is disposed next to the imaging unit 16 in the X-axis direction such that the rotation axis of the fan 14-1 and the optical axis OA are parallel, the thickness in the X-axis direction increases, but the thickness in the X-axis direction can be reduced by arranging the rotation axis of the fan 14-1 and the optical axis OA such that they are orthogonal to each other.

Furthermore, as shown in FIG. 6B, if the fan 14-1 is disposed to overlap the imaging unit 16 in the Z-axis direction, the thickness in the Z-axis direction increases, but the thickness in the Z-axis direction can be reduced by arranging the rotation axis of the fan 14-1 and the optical axis OA such that they are orthogonal to each other. Referring back to FIG. 4B, description will be continued.

As the fan 14-1 rotates, the wind flows in the positive direction of the Y-axis. The wind exhausted from the fan 14-1 is introduced into the heat dissipation member 14-6.

The heat dissipation member 14-6 serves both as a flow path for guiding the exhaust air from the fan 14-1 to the exhaust port 14-3 and as a heat storage part. With this configuration, the exhaust air from the fan 14-1 can be guided to the exhaust port 14-3 in contrast to a case in which the heat dissipation member 14-6 is not provided. An example of the heat dissipation member 14-6 is a material with a large heat capacity, such as die-cast aluminum alloy. An example of the heat dissipation member 14-6 is a heat dissipation fin, which has a protruding fin structure. With this configuration, the surface area of the heat dissipation member 14-6 can be increased, and thus the heat generated inside the camera can be efficiently stored and the heat can be efficiently discharged by exhausting air from the fan 14-1. The height of the fin decreases as it approaches the exhaust port 14-3 from the fan 14-1.

The envelope 14-5 forms a space along with the fan 14-1 and the heat dissipation member 14-6. This space includes a flow path from the intake port 14-2 to the exhaust port 14-3. With this configuration, the heat dissipation part 14 can be made into a unit, and thus the heat dissipation part 14 can be easily attached and removed. Therefore, the heat dissipation part 14 can be easily replaced. Further, compared to a case in which the envelope 14-5 is not provided, the space can be divided into subassemblies, and thus dirt, dust, and water can be prevented from entering the main body. Further, the exhaust air from the fan 14-1 can pass through the heat dissipation member 14-6 and be discharged from the exhaust port 14-3 without going into the camera body 1. Further, it is possible to prevent dirt and dust from entering the inside of the heat dissipation part 14. Even if water droplets enter the camera body 1 from either or both of the intake port 14-2 and the exhaust port 14-3 of the heat dissipation part 14, the water droplets will remain in the heat dissipation part 14, and thus it is possible to prevent water droplets from entering inside the heat dissipation part 14 in the camera body 1.

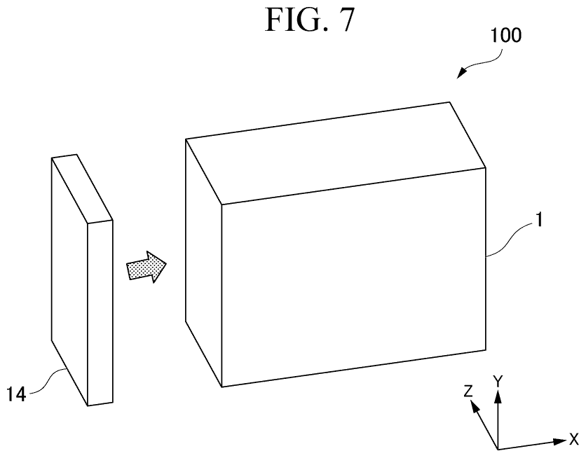

FIG. 7 is a diagram showing an example of assembling the imaging device according to the present embodiment. As shown in FIG. 7, the heat dissipation part 14 is attached to a portion that is not touched by a user when an image is captured with the imaging device 100, such as the side surface of the camera body 1. Specifically, the heat dissipation part 14 is disposed on the left side of the camera body 1 (negative side of the X-axis). The heat dissipation part 14 is attached to the housing of the imaging device 100 by being moved from the negative direction to the positive direction of the X-axis.

Furthermore, by attaching the heat dissipation part 14 to a portion that is not touched by the user when the imaging device 100 captures an image, it is possible to prevent a portion that is touched by the user, such as a grip part, from becoming hot. Furthermore, by attaching the heat dissipation part 14 to a portion that is not touched by the user when the imaging device 100 captures an image, it is possible to efficiently dissipate heat while maintaining operability similar to that of the imaging device 100 that does not include the heat dissipation part 14.

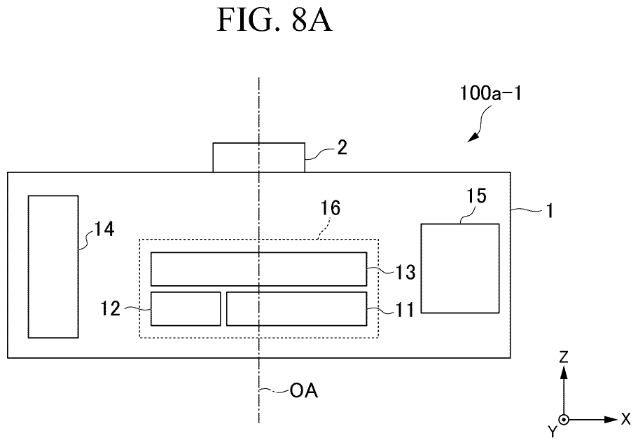

FIG. 8A is a schematic diagram showing Example 2 of an imaging device according to the present embodiment. An imaging device 100a-1 includes the camera body 1 and the lens unit 2. The lens unit 2 is attached to the camera body 1. The lens unit 2 includes an optical system arranged along the optical axis OA within the lens barrel thereof. The optical system guides an incident subject light flux to the imaging unit 16 of the camera body 1.

The imaging unit 16 includes the first processing unit 11, the second processing unit 12, and the image sensor 13. The first processing unit 11 and the image sensor 13, and the second processing unit 12 and the image sensor 13 are disposed in the housing at positions at which they overlap in the direction of the optical axis OA of the imaging device 100.

FIG. 8B is a schematic diagram showing Example 3 of an imaging device according to the present embodiment. An imaging device 100a-2 includes the camera body 1 and the lens unit 2. The lens unit 2 is attached to the camera body 1. The lens unit 2 includes an optical system arranged along the optical axis OA within the lens barrel thereof. The optical system guides an incident subject light flux to the imaging unit 16 of the camera body 1.

The imaging unit 16 includes the first processing unit 11, the second processing unit 12, and the image sensor 13. The first processing unit 11 and the second processing unit 12 overlap in the Z-axis direction.

According to the imaging device 100 according to the present embodiment, the heat dissipation part 14 including the fan 14-1 is disposed at the left side edge when viewed from the imaging device operator when the imaging device 100 is held at a lateral position in the imaging device 100.

With this configuration, the heat dissipation part 14 including the fan 14-1 can be disposed at the left side edge when viewed from the imaging device operator when the imaging device 100 is held at a lateral position, and thus it is possible to reduce noise such as the rotation noise of the fan 14-1 from being collected by the microphones 3-1 and 3-2 provided around the lens mount 2-1.

Furthermore, in the imaging device 100, the heat dissipation part 14 takes in air from the bottom and exhausts air from the top when the imaging device 100 is held at a lateral position.

With this configuration, when the imaging device 100 is held at a lateral position, air can be taken in from the bottom and exhausted from the top, and thus it is possible to prevent the air being taken in from being heated by the exhausted air, compared to a case in which air is taken in from the top and exhausted from the bottom, resulting in efficiency discharge of heat.

Furthermore, in the imaging device 100, the rotation axis of the fan 14-1 is orthogonal to the optical axis of the imaging device 100. With this configuration, the thickness (thickness in the Z-axis direction) of the imaging device 100 can be reduced as compared to a case in which the rotation axis of the fan 14-1 and the optical axis direction OA are not orthogonal to each other. Therefore, the imaging device 100 can be downsized. That is, although the thickness in the X-axis direction will increase if the fan 14-1 is disposed next to the imaging unit 16 in the X-axis direction and thus the rotation axis of the fan 14-1 and the optical axis OA are parallel, the thickness in the X-axis direction can be reduced by arranging the rotation axis of the fan 14-1 and the optical axis OA such that they are orthogonal to each other. Furthermore, although the thickness in the Z-axis direction will increase if the fan 14-1 is disposed overlapping the imaging unit 16 in the Z-axis direction, the thickness in the Z-axis direction can be reduced by arranging the rotation axis of the fan 14-1 and the optical axis OA such that they are orthogonal to each other.

Further, the imaging device 100 includes the image sensor 13 and one or both of the first processing unit 11 and the second processing unit 12 as processing units, and the fan 14-1 is disposed at a position at which it does not overlap the image sensor 13 and one or both of the first processing unit 11 and the second processing unit 12 as processing units in the optical axis direction of the imaging device 100.

With this configuration, the thickness (thickness in the Z-axis direction) of the imaging device 100 can be reduced compared to a case in which the fan 14-1 is disposed at a position at which it overlaps the image sensor 13 and one or both of the first processing unit 11 and the second processing unit 12 as processing units in the optical axis direction of the imaging device 100. Accordingly, the imaging device 100 can be downsized.

Further, in the imaging device 100, the processing unit includes the first processing unit 11 and the second processing unit 12, and the fan 14-1 is disposed at a position at which it does not overlap any of the image sensor 13, the first processing unit 11, and the second processing unit 12 in the optical axis direction of the imaging device 100.

With this configuration, the thickness (thickness in the Z-axis direction) of the imaging device 100 can be reduced compared to a case in which the fan 14-1 is disposed at a position at which it overlaps the image sensor 13, the first processing unit 11, and the second processing unit 12 in the optical axis direction of the imaging device 100. Therefore, the imaging device 100 can be downsized.

Further, in the imaging device 100, the processing unit includes the first processing unit 11 and the second processing unit 12, and the first processing unit 11, the second processing unit 12, and the image sensor 13 are disposed at a position at which they overlap in the optical axis direction of the imaging device. With this configuration, the width (thickness in the X-axis) of the imaging device 100 can be reduced compared to a case in which the first processing unit 11 and the second processing unit 12 are disposed side by side on the X-axis. Therefore, the imaging device 100 can be downsized.

Further, in the imaging device 100, the processing unit includes the first processing unit 11 and the second processing unit 12, and any two of the first processing unit 11, the second processing unit 12, and the image sensor 13 are disposed at a position at which they overlap in the optical axis direction of the imaging device.

With this configuration, the thickness (thickness in the Z-axis direction) of the imaging device 100 can be reduced compared to a case in which the fan 14-1 is disposed at a position at which it overlaps the image sensor 13, the first processing unit 11, and the second processing unit 12 in the optical axis direction of the imaging device 100, and the width (thickness in the X-axis) can be reduced compared to a case in which the first processing unit 11 and the second processing unit 12 are disposed side by side on the X-axis. Therefore, the imaging device 100 can be downsized.

Furthermore, in the imaging device 100, the heat dissipation part 14 may be disposed at a portion that is not touched by the user when the imaging device 100 captures an image. With this configuration, it is convenient for the fan to take in and exhaust air because the basic way of holding the imaging device 100 at a lateral position is to hold the right side of the camera body 1 with the right hand and to hold the lens unit with the left hand in general, and thus there are no obstacles (hands are not covered) on the left side of the camera body 1. When the imaging device 100 captures an image, the operability can be the same as that when the fan 14-1 is not mounted, compared to a case in which the heat dissipation part 14 is disposed at a portion touched by the user.

### Modified Example of Embodiment

FIG. 1 can be applied to an example of an imaging device according to a modified example of the embodiment.

An imaging device 100b includes the camera body 1 and the lens unit 2. The lens unit 2 is attached to the camera body 1.

The imaging device 100b further includes heat transfer members 17, 18-1, 18-2, and 18-3 and the like that transfer heat from any one of the first processing unit 11, the second processing unit 12, and the image sensor 13 to the heat dissipation part 14, the battery chamber 15, and the like in the imaging device 100 described above.

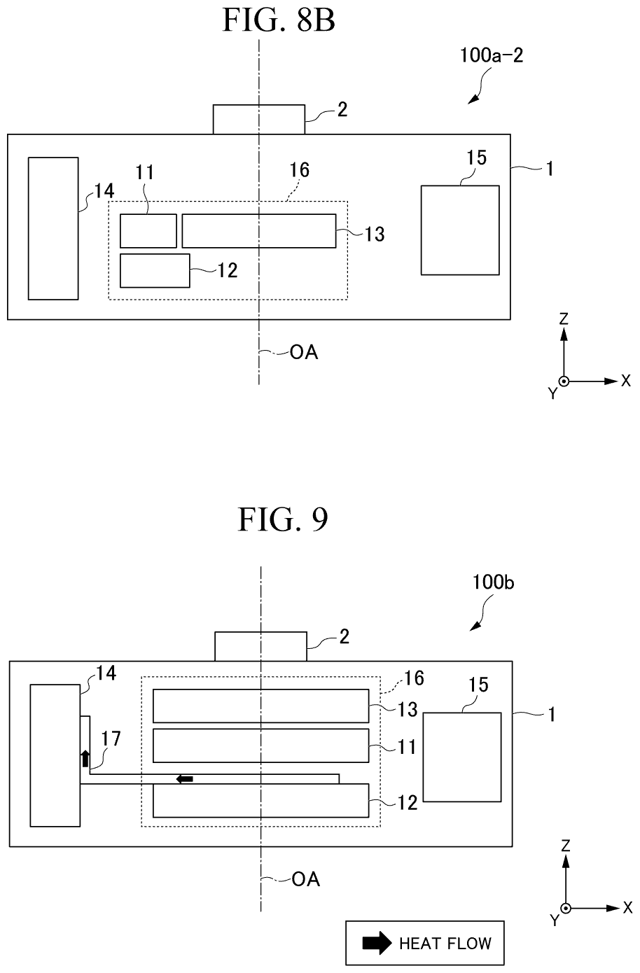

FIG. 9 is a diagram showing Example 1 of an imaging device according to a modified example of the embodiment. FIG. 9 is a cross-sectional view of the imaging device 100 shown in FIG. 1 taken along A1-A2 viewed in the direction of the arrow.

The heat transfer member 17 guides the heat inside the housing to the heat dissipation member 14-6 of the heat dissipation part 14. The heat stored in the heat dissipation member 14-6 is discharged from the exhaust port 14-3 along with the outside air supplied from the fan 14-1. The heat dissipation member 14-6 serves as a heat sink and a flow path. An example of the heat transfer member 17 is a material with excellent thermal conductivity, such as graphite-based aluminum composite material (ACM-a). As shown by the arrow in FIG. 9, the heat generated in the second processing unit 12 is transferred through the heat transfer member 17 and is forcibly exhausted by the fan 14-1. With this configuration, the heat generated by the second processing unit 12 can be guided to the heat dissipation part 14, and thus the heat can be efficiently exhausted.

In FIG. 9, although heat is transferred from the front side of the second processing unit 12 (between the first processing unit 11 and the second processing unit 12), the present invention is not limited thereto and, for example, heat may be transferred from the back side of the second processing unit 12 (between the second processing unit 12 and the back surface of the camera body 1), or the like.

The heat transfer member 17 may be applied to the above-described imaging device 100a-1 and imaging device 100a-2.

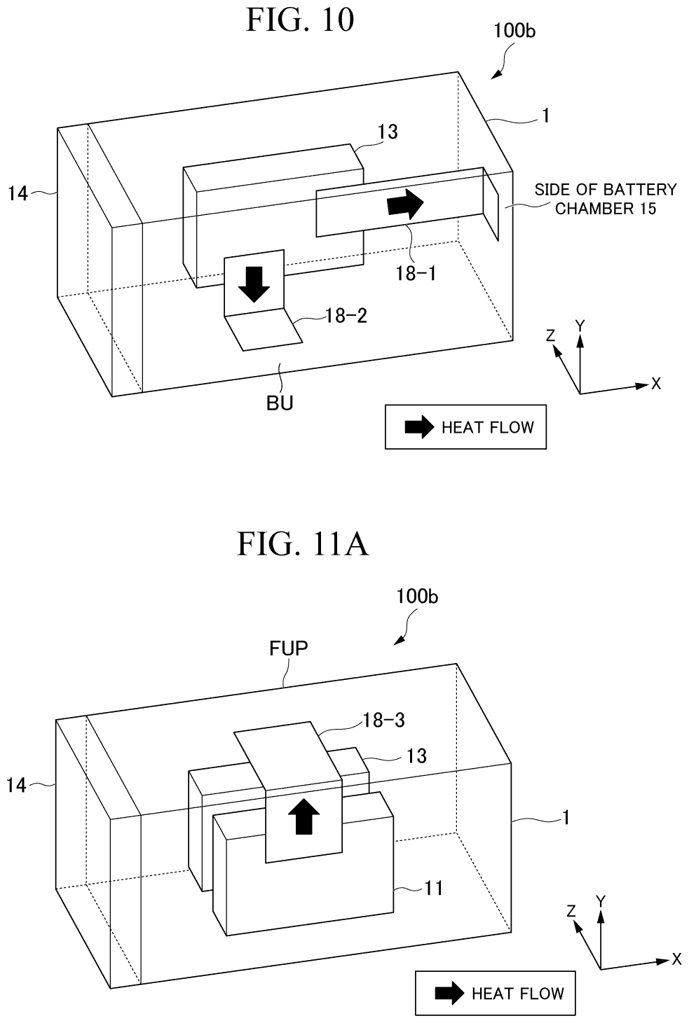

FIG. 10 is a diagram illustrating Example 2 of an imaging device according to a modified example of the embodiment. FIG. 10 is a diagram of the inside of the imaging device 100b viewed from the negative side of the Z-axis. FIG. 10 shows a state in which only the image sensor 13 is assembled to the main body, and the first processing unit 11 and the second processing unit 12 are removed.

An example of the heat transfer member 18-1 is a material with excellent thermal conductivity such as graphite. The heat transfer member 18-1 functions as a heat flow path. The heat transfer member 18-1 is disposed to connect the image sensor 13 and the side of the battery chamber 15. As shown by the arrow in FIG. 10, heat generated by the image sensor 13 is transferred to the side of the battery chamber 15 via the heat transfer member 18-1. The heat transfer member 18-1 may be applied to the above-described imaging device 100a-1 and imaging device 100a-2.

An example of the heat transfer member 18-2 is a material with excellent thermal conductivity such as graphite. The heat transfer member 18-2 functions as a heat flow path. The heat transfer member 18-2 is disposed to connect the image sensor 13 and the bottom side BU of the imaging device 100b.

As shown by the arrow in FIG. 10, heat generated by the image sensor 13 is transferred to the bottom side BU of the imaging device 100b via the heat transfer member 18-2. With this configuration, the heat generated by the image sensor 13 can be guided in a direction different from a direction of the heat generated by the second processing unit 12, and thus the entire camera body 1 can be utilized to dissipate the heat. The heat transfer member 18-2 may be applied to the above-described imaging device 100a-1 and imaging device 100a-2.

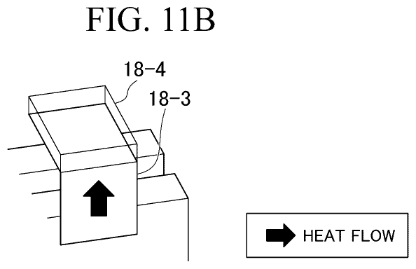

FIG. 11A is a diagram showing Example 3 of an imaging device according to a modified example of the embodiment. FIG. 11A is a diagram of the inside of the imaging device 100b viewed from the negative side in the positive direction of the Z-axis. FIG. 11A shows a state in which the second processing unit 12 is removed from the imaging device 100.

The imaging device 100b further includes a heat transfer member 18-3 that transfers heat from the first processing unit 11 to the upper part of a front cover.

An example of the heat transfer member 18-3 is a material with excellent thermal conductivity such as graphite. The heat transfer member 18-3 functions as a heat flow path. The heat transfer member 18-3 is disposed to connect the first processing unit 11 and the upper side FUP of the front cover when the first processing unit 11 is attached to the imaging device 100. Heat generated in the first processing unit 11 is transferred to the upper side FUP of the front cover via the heat transfer member 18-3. Further, the heat generated by the first processing unit 11 is transferred to a heat sink on the back side of the imaging device 100.

FIG. 11B is a diagram showing Example 3 of an imaging device according to a modified example of the embodiment. As shown in FIG. 11B, a heat storage part 18-4 that accumulates heat generated by the first processing unit 11 may be provided. With this configuration, the heat generated by the first processing unit 11 can be guided in a direction different from a direction of heat generated by the second processing unit 12, and thus the entire camera body 1 can be used to dissipate the heat.

The imaging device 100b described above may be configured such that heat generated by the first processing unit 11 is transferred to the upper part of the front cover. Further, the heat generated by the first processing unit 11 may be transferred to the heat sink on the back surface. Further, a heat storage part that stores heat generated by the first processing unit 11 may be provided. Further, the heat generated by the first processing unit 11 may be transferred to the battery chamber side and the bottom side. There are heat transfer destinations in three directions: the battery chamber side, the bottom side, and the upper part of the front cover, and these three locations may be used in any combination.

Although the embodiment of the present invention has been described above in detail with reference to the drawings, a specific configuration is not limited to this embodiment, and also includes designs and the like within the scope of the gist of the present invention.

### REFERENCE SIGNS LIST

1 Camera body
2 Lens unit
2-1 Lens mount
3-1, 3-2 Microphone
11 First processing unit
12 Second processing unit
13 Image sensor
14 Heat dissipation part
14-1 Fan
14-2 Intake port
14-3 Exhaust port
14-4 One main surface
14-5 Envelope
14-6 Heat dissipation member
14-11 Motor
14-12 Runner
14-13 Scroll
15 Battery chamber
16 Imaging unit
17, 18-1, 18-2, 18-3 Heat transfer member
100, 100a-1, 100a-2, 100b Imaging device

1-14. (canceled)

15. An imaging device comprising:
a first heat transfer member configured to transfers heat is disposed at an upper side edge when viewed from an imaging device operator when the imaging device is held at a lateral position.

16. The imaging device according to claim 15, comprising:
a heat storage part configured to accumulates heat transferred via the first heat transfer member.

17. The imaging device according to claim 15, comprising:
a fan is disposed at a part of heat transfer destinations from the first heat transfer member to the outside of the imaging device.

18. The imaging device according to claim 15, comprising:
a heat dissipation part including a fan is disposed at a part of heat transfer destinations from the first heat transfer member to the outside of the imaging device.

19. The imaging device according to claim 17, wherein a rotation axis of the fan is orthogonal to an optical axis of the imaging device.

20. The imaging device according to claim 17, comprising:
an image sensor; and
a processing unit,
wherein the fan is disposed at a position at which the fan does not overlap the image sensor and the processing unit in an optical axis direction of the imaging device.

21. The imaging device according to claim 20, wherein the processing unit includes a first processing unit and a second processing unit, and
wherein the fan is disposed at a position at which the fan does not overlap any of the image sensor, the first processing unit, and the second processing unit in the optical axis direction of the imaging device.

22. The imaging device according to claim 20, wherein the processing unit includes a first processing unit and a second processing unit,
wherein the first processing unit, the second processing unit, and the image sensor are disposed at a position at which the first processing unit, the second processing unit, and the image sensor overlap in the optical axis direction of the imaging device.

23. The imaging device according to claim 20, wherein the processing unit includes a first processing unit and a second processing unit,
wherein any two of the first processing unit, the second processing unit, and the image sensor are disposed at a position at which the any two of the first processing unit, the second processing unit, and the image sensor overlap in the optical axis direction of the imaging device.

24. The imaging device according to claim 18, wherein the heat dissipation part is disposed at a portion that is not touched by a user when the imaging device captures an image.

25. The imaging device according to claim 18, comprising an intake port and an exhaust port provided on one main surface of the heat dissipation part.

26. The imaging device according to claim 25, wherein the intake port is provided at a lower part of the one main surface, and the exhaust port is provided at an upper part of the one main surface.

27. The imaging device according to claim 26, wherein the one main surface is a side of the imaging device.

28. The imaging device according to claim 25, wherein the heat dissipation part further includes a heat dissipation member that guides the exhaust air of the fan to the exhaust port.

29. The imaging device according to claim 28, further comprising a first heat transfer member that guides heat within a housing to the heat dissipation member.

30. The imaging device according to claim 28, further comprising a second heat transfer member capable of dissipating heat within the housing in a direction different from a direction of the heat dissipation member.

31. An imaging device comprising:
a heat dissipation part including a fan is disposed at a left side edge when viewed from an imaging device operator when the imaging device is held at a lateral position.

32. The imaging device according to claim 15, wherein the heat dissipation part takes in air from the bottom and exhausts air from top when the imaging device is held at a lateral position.
